(19) United States
(12) Patent Application Publication
(10) Pub. No.: US 2026/0277536 A1
(43) Pub. Date: Sep. 17, 2026

(54) A METHOD AND APPARATUS FOR EXTERNAL ORIENTATION CONTROL FOR CONVERSATIONAL IMMERSIVE AUDIO

(71) Applicant: NOKIA TECHNOLOGIES OY, Espoo (FI)

(72) Inventors: Sujeet Shyamsundar MATE, Tampere (FI); Lauros PAJUNEN, Helsinki (FI); Lasse Juhani LAAKSONEN, Tampere (FI)

(21) Appl. No.: 19/471,221

(22) PCT Filed: Mar. 12, 2024
(86) PCT No.: PCT/EP2024/056455

§ 371 Date: Sep. 30, 2025

Related U.S. Application Data
(60) Provisional application No. 63/494,534, filed on Apr. 6, 2023.

(51) Int. Cl. G06F 3/16; G06F 3/01

(52) U.S. Cl. CPC G06F 3/165; G06F 3/012

(57) ABSTRACT

Various embodiments describe a method and an apparatus for external orientation control for conversational immersive audio. An example apparatus includes at least one processor; and at least one non-transitory memory storing instructions that, when executed with the at least one processor, cause the apparatus to perform: receiving an external orientation information; receiving an external orientation control information; selecting an external orientation modification; modifying rendering orientation of spatially rendered orientation according to the selected external orientation modification; and rendering spatial audio according to the modified rendering orientation.

### TECHNICAL FIELD

The example and non-limiting embodiments relate generally to immersive audio and, more particularly, to external orientation control for conversational immersive audio.

### BACKGROUND

It is known to provide immersive audio.

### SUMMARY OF THE INVENTION

The following summary is merely intended to be an example. The summary is not intended to limit the scope of the claims.

An apparatus includes: at least one processor; and at least one non-transitory memory storing instructions that, when executed with the at least one processor, cause the apparatus to perform: receiving an external orientation information; receiving an external orientation control information; selecting an external orientation modification; modifying rendering orientation of spatially rendered orientation according to the selected external orientation modification; and rendering spatial audio according to the modified rendering orientation.

The example apparatus may further include, wherein the external orientation control information comprises interactive interaction signal to enable, disable, or freeze application of the external orientation information.

The example apparatus may further include, wherein the apparatus is further caused to, receive head-tracking information, and wherein the spatial audio is rendered further based on the head-tracking information.

The example apparatus may further include, wherein the external orientation control information comprises a head orientation flag for freezing head orientation to a last rendered spatial audio orientation. In an embodiment, the head tracking is frozen/maintained, and audio is rendered with disabled head tracking and a default or corresponding head-tracked front orientation at time of applying the freezing. For example, this may be either a previously head-tracked orientation when previous state was enabled or the default front when previous state was disabled, in which case there is no change to rendering.

The example apparatus may further include, wherein the external orientation control information comprises a head orientation flag to enable or disable head-tracking,

The example apparatus may further include, wherein when the head orientation flag is set to disable the head-tracking, the head tracking is disabled and audio is rendered with disabled head tracking and default or corresponding front orientation.

The example apparatus may further include, wherein when the head orientation flag is set to enable the head-tracking, the head tracking is enabled and audio is rendered based on head orientation.

The example apparatus may further include, wherein the apparatus is further caused to: receive a reference data for defining a scene orientation; and apply the scene orientation data.

The example apparatus may further include, wherein the apparatus is further caused to combine the external orientation data with head tracking data.

The example apparatus may further include,, wherein the apparatus is further caused to receive external orientation activation time for indicating that the external orientation information is to be applied at a current frame or at a future frame.

The example apparatus may further include,, wherein the apparatus is further caused to receive combined information affecting the external orientation information, and wherein the combined information comprises a combination of two or more of a scene orientation information provided by a sender user equipment (UE), device orientation data provided by the sender UE, or local scene orientation information provided by a receiver UE.

A method includes: receiving an external orientation information; receiving an external orientation control information; selecting an external orientation modification; modifying rendering orientation of spatially rendered orientation according to the selected external orientation modification; and rendering spatial audio according to the modified rendering orientation.

The example method may further include, wherein the external orientation control information comprises interactive interaction signal to enable, disable, or freeze application of the external orientation information. In an embodiment, the external orientation control information may be applied either by an end user interaction or via application preferences. An example of the interactive interaction signal include, but is not limited to, an interactive Boolean interaction signal.

The example method may further include receiving head-tracking information, wherein the spatial audio is rendered further based on the head-tracking information.

The example method may further include, wherein the external orientation control information comprises a head orientation flag for freezing head orientation to a last rendered spatial audio orientation. In an embodiment, the head tracking is frozen/maintained, and audio is rendered with disabled head tracking and a default or corresponding head-tracked front orientation at time of applying the freezing. For example, this may be either a previously head-tracked orientation when previous state was enabled or the default front when previous state was disabled, in which case there is no change to rendering.

The example method may further include, wherein the external orientation control information comprises a head orientation flag to enable or disable head-tracking, The example method may further include, wherein when the head orientation flag is set to disable the head-tracking, the head tracking is disabled and audio is rendered with disabled head tracking and default or corresponding front orientation.

The example method may further include, wherein when the head orientation flag is set to enable the head-tracking, the head tracking is enabled and audio is rendered based on head orientation.

The example method may further include: receiving a reference data for defining a scene orientation; and applying the scene orientation data.

The example method may further include combining the external orientation data with head tracking data.

The example method may further include receiving external orientation activation time for indicating that the external orientation information is to be applied at a current frame or at a future frame.

The example method may further include receiving combined information affecting the external orientation information, and wherein the combined information comprises a combination of two or more of a scene orientation information provided by a sender user equipment (UE), device orientation data provided by the sender UE, or local scene orientation information provided by a receiver UE.

Another apparatus includes: means for receiving an external orientation information; means for receiving an external orientation control information; means for selecting an external orientation modification; means for modifying rendering orientation of spatially rendered orientation according to the selected external orientation modification; and means for rendering spatial audio according to the modified rendering orientation.

The example apparatus may further include, wherein the apparatus further comprises means for performing the one or more methods as described in any of the previous paragraphs.

### BRIEF DESCRIPTION OF DRAWINGS

The foregoing embodiments and other features are explained in the following description, taken in connection with the accompanying drawings, wherein:

FIG. 1 is a block diagram of a possible and non-limiting example system in which the example embodiments may be practiced;

FIG. 2 illustrates an example of IVAS renderer head-tracking data handling.

FIG. 3 illustrates an example scenario.

FIG. 4 illustrates another example scenario.

FIG. 5 illustrates an example of orientation handling, in accordance with an embodiment.

FIG. 6 illustrates a further extension of the proposed orientation handling according as described in FIG. 5.

FIG. 6b. illustrates an alternative to FIG. 6, in accordance with an embodiment.

FIG. 7 illustrates an example additional description beyond system described in FIG. 6.

FIG. 8 is an example apparatus, which may be implemented in hardware, caused to implement external orientation control for conversational immersive audio, based on the examples described herein.

FIG. 9 shows a schematic representation of non-volatile memory media.

FIG. 10 is an example method to implement the examples described herein, in accordance with an embodiment.

### DETAILED DESCRIPTION

The following abbreviations that may be found in the specification and/or the drawing figures are defined as follows:
3GPP third generation partnership project
5G fifth generation
5GC 5G core network
AMF access and mobility management function
CU central unit
DU distributed unit
eNB (or eNodeB) evolved Node B (e.g., an LTE base station)
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
IVAS immersive voice and audio services
LTE long term evolution
MAC medium access control
MME mobility management entity
MPEG moving picture experts group
ng or NG new generation
ng-eNB or NG-eNB new generation eNB
NR new radio
N/W or NW network
PDCP packet data convergence protocol
PHY physical layer
RAN radio access network
RLC radio link control
RRH remote radio head
RRC radio resource control
RTCP RTP control protocol
RTP real-time transport protocol
RU radio unit
Rx receiver
SDAP service data adaptation protocol
SGW serving gateway
SMF session management function
Tx transmitter
UE user equipment (e.g., a wireless, typically mobile device)
UPF user plane function
VR virtual reality

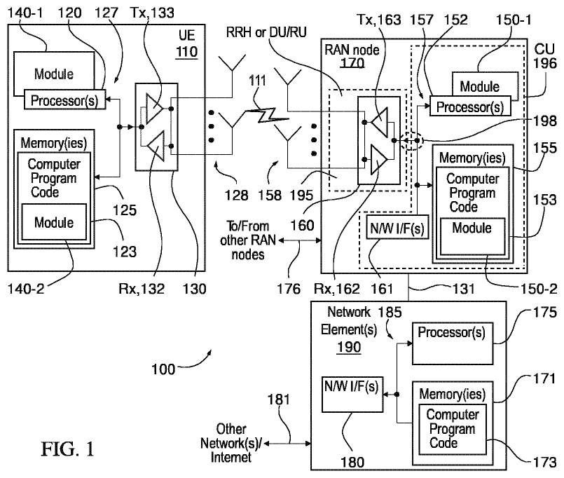

Turning to FIG. 1, this figure shows a block diagram of a possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured to implement external orientation control for conversational immersive audio. Computer program code 173 may also be configured to implement external orientation control for conversational immersive audio.

### 3GPP IVAS

The immersive voice and audio services (IVAS) codec is an extension of the 3GPP enhanced voice services (EVS) codec and intended for new immersive voice and audio services over 4G/5G. Such immersive services include, e.g., immersive voice and audio for virtual reality (VR). The multi-purpose audio codec is expected to handle the encoding, decoding and rendering of speech, music and generic audio. It is expected to support a variety of input formats, such as channel-based and scene-based inputs. It is also expected to operate with low latency to enable conversational services as well as support high error robustness under various transmission conditions.

The IVAS codec is expected to provide an internal renderer and at least a means to work in combination with a suitable external renderer. For example, there can be an external renderer interface specified as part of the IVAS codec.

The IVAS codec also includes features such as orientation handling at the receiver UE. The orientation handling is important in order to present the spatial audio as intended. For example, applying head-tracking to binaural rendering is one type of spatial audio orientation handling. Various embodiments propose methods and apparatuses to enable orientation handling in a conversational immersive audio call. This is relevant for audio conversational immersive audio scenarios as well as for immersive audio-visual conversational scenarios.

Various embodiments specify the way different orientation data (including head-tracking data and modifications applied to it) is processed in combination in a practical immersive audio renderer (e.g., an IVAS internal renderer), and propose additional control methods for interactively selecting whether the one or more orientations should be applied for rendering and how. This interactive selection can be based on user or application preference. For example, consider a use case of switching audio scene orientation in receiver UE rendering based on camera selection at sender UE, where the user's current operating mode dictates the desired audio behavior.

### IVAS Publication Collaboration Software Baseline

The current IVAS Codec Baseline renderer version provides means for orientation handling by ingesting reference data for defining the scene orientation in certain use cases where, e.g., a device position ‘r’ can be used as the front of the scene. Such reference data may in general be, e.g., orientation data or a vector between two points. In an alternative operation mode, the head-tracking unit in the renderer of the IVAS Codec Baseline considers an average orientation of the user as a slowly evolving natural reference for the frontal direction. For example, for a user riding on a bus, the movements of the vehicle turning at intersections are slowly filtered out such that they may not significantly affect the rendered scene orientation. Various embodiments consider orientation signals/data that are separate from the head-tracking data. For example, a reference direction based on the receiver UE position relates to head-tracking data and not the scene data itself, which is of interest. These also need to be considered in a separate processing step in order to not have the reference data or averaging operations present in the IVAS Codec Baseline renderer incorrectly modify these data.

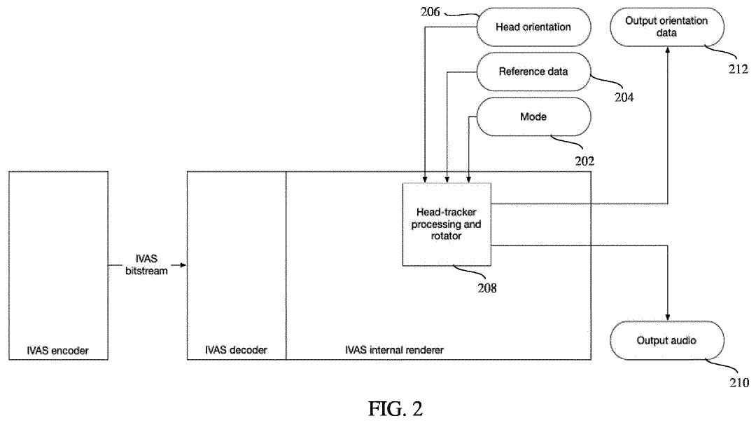

FIG. 2 illustrates an example of IVAS renderer head-tracking data handling. In this example, there may be, e.g., 3 modes 202, where a first mode corresponds to provision of reference data 204 indicating a front direction for the rendering. For example, this may be a mobile device position relative to user's face, headphones or the equivalent. A second mode can correspond to averaging a reference, e.g., a mechanism for removing slowly evolving orientation changes from the head-tracking data. A third mode may be a default mode or regular mode, which does not apply any reference data or averaging for the head-tracking or orientation data 206. The head-tracker processing 208 includes a rotator, which may apply the final rotation of the scene for rendering of the binaural audio 210 over headphones. The final orientation data 212 may also be provided from the renderer to be used externally as needed.

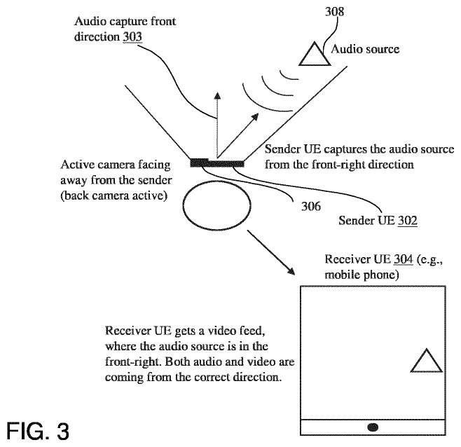

FIG. 3 illustrates an example scenario. In this example scenario, a sender UE 302 is having a video call with a receiver UE 304. The sender UE 302 is recording a video using a back camera 306 of the sender UE 302. In this example, it is assumed that the front direction for the audio capture 303 is away from the user (e.g., outwards from the back of the sender UE 302). The sender UE 302 captures an audio source 308 in the front-right direction as well as the sender's own voice is captured by the in-device microphone(s). Subsequently, the sender UE 302 sends the corresponding video and audio to the receiver UE 304. Everything works as expected. This is because the captured audio is oriented with reference “front” in a particular direction and the back camera captures the visual scene with the audio source visible in the correct direction. There is no incompatibility in between the audio and video content capture and delivery.

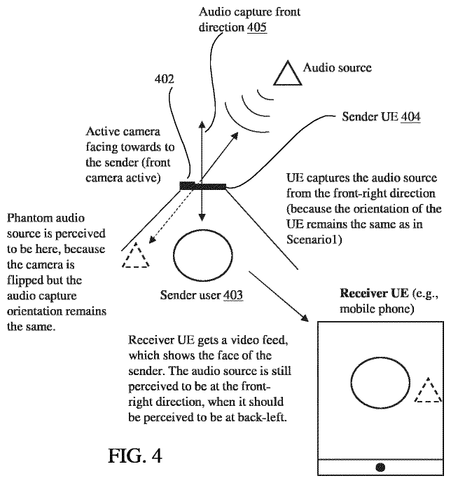

FIG. 4 illustrates another example scenario. In this example scenario, the sender switches to use a front camera 402 to capture the video (e.g., the sender user's 403 face). However, the sender UE 404 itself remains in the same position and orientation as in the scenario explained in FIG. 3, just the active camera is switched. The frontal direction for the audio capture 405 remains in the same direction (outwards from the back of the sender UE 404). A receiver thus hears a phantom source in the same direction as in scenario of FIG. 3, when in reality the audio should be coming from the back-left direction. There is a mismatch between the received video and audio.

This inconsistency in the audio and visual representation needs to be addressed in such a way that it works in all scenarios. Absence of a mechanism for proper handling of such changes may make the consumption of spatial audio in conversational audio as well as audio-visual scenarios complicated for the end user. This may have an adverse impact on the usability of the IVAS standard and consequently negatively impact its widespread adoption.

In an example, to correct the audio source direction, the active camera may be indicated to the receiver, which may then perform correct rotations to the audio. Alternatively, the sender may re-adjust the front of the capturing direction based on which camera is active.

Various embodiments relate to a method for external orientation handling where external orientation control information and external orientation information is provided to enable user intent dependent application of external orientation information and to achieve spatial audio rendering orientation that is aligned with the user intent. An example method may comprise following:
receiving an external orientation information;
receiving an external orientation control information;
selecting of the external orientation modification;
modifying rendering orientation of the spatially rendered orientation according to the selected external orientation modification; and
rendering spatial audio according to the modified rendering orientation.

In an embodiment, the external orientation modifications may be selected by a user. In another embodiment, the external orientation modifications may be automatically selected, e.g., by a UE or application preferences.

In an embodiment, the selecting of the external orientation modification is performed based on the received external orientation control information.

In an embodiment, the external orientation control information may comprise interactive interaction signal to enable, disable, or freeze application of external orientation information. In an embodiment, the external orientation control information may be applied either by an end user interaction or via application preferences.

In another embodiment, the external orientation control information comprises information for enabling freezing of head orientation to the last rendered spatial audio orientation.

In another embodiment, the control external orientation information comprises information for enabling/disabling head tracking to stop head tracking and render audio with disabled head tracking and default or corresponding front orientation.

In an embodiment, enable may mean applying, for example, the external orientation as is when there is no future activation or interpolation) or interpolate based on it. For example, in the simple case, external orientation was 45-degree left yaw, new value is 55-degree left way—> what is applied to final orientation based on this input is 55-degree left yaw rotation relative to format's default orientation. In an embodiment, the contribution from head-tracking data may still modify this to something else for rendering.

In an embodiment, disable may mean do not apply, for example, the external orientation. For example, the external orientation was 45-degree left yaw, new value is 55-degree left yaw—> what is applied to final orientation based on this input is 0-degree rotation relative to format's default orientation. In an embodiment, the contribution from head-tracking data may still modify this to something else for rendering.

In an embodiment, freeze may mean applying the existing external orientation and keep it there until otherwise instructed (via enable/disable). For example, the external orientation was 45-degree left yaw, new value is 55-degree left yaw—> what is applied to final orientation based on this input is 45-degree left yaw. In an embodiment, the contribution from head-tracking data may still modify this to something else for rendering.

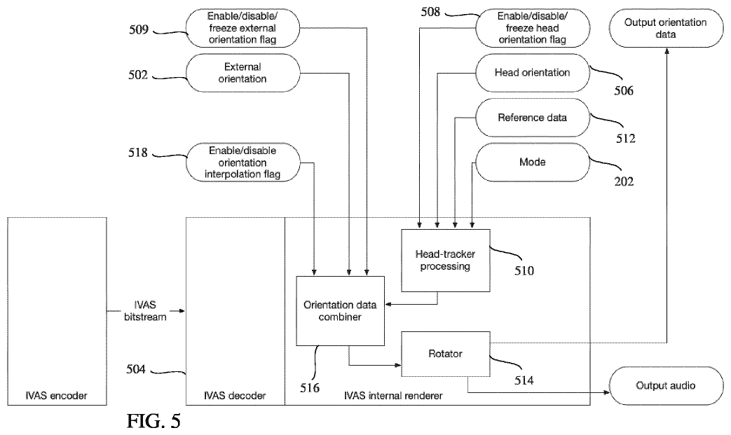

FIG. 5 illustrates an example of orientation handling, in accordance with an embodiment. In this example, at least one external orientation 502 is provided to a renderer 504 in addition to head-tracking or orientation data 506. The head-tracking or orientation data 506 may be processed similarly as explained in FIG. 2. In an embodiment a head orientation flag that indicates at least enabling, disabling and/or freezing 508 of the head-tracking is added. When head-tracking is enabled, the head-tracking processing 510 is thus carried out as explained in FIG. 2. When head-tracking is disabled, the default front is kept at user's front (as far as head-tracking data is considered) and head turns do not affect the rendering. In some embodiments, the reference data 512 input may be applied. Freezing, on the other hand, refers to setting the current head-tracked direction as the front that is now maintained without further head-tracking data affecting the rendering. Thus, when a user is looking to the right, and freezing is applied, the right-hand side direction is maintained in front of the user regardless of subsequent head orientation changes.

In an embodiment, the rotator functionality 514 is now detached from the head-tracker processing 510. This is because the external orientation data 502 needs to be combined with the head-tracker processing 510 output in by an orientation data combiner 516. The orientation data combiner 516 may further accept an external orientation flag 509, as described above for head-tracking data as an input, e.g., a command to enable, disable, or freeze application of the external orientation information. The functionality is similar, only now it controls the application of the external orientation 502. The external orientation 502 may change significantly at any update, and therefore in some cases it can be desirable to smooth this change. For this reason, an interpolation functionality 518 is provided. The interpolation functionality 518 may be controlled more precisely in various embodiments. However, in this embodiment, the interpolation functionality 518 is described only in terms of enabling and disabling. For example, when external orientation is changed 180 degrees (yaw) according to the camera view signaling above, it may generally be desirable to apply the change rather instantly. Thus, the orientation interpolation flag may be set to disable in such use case.

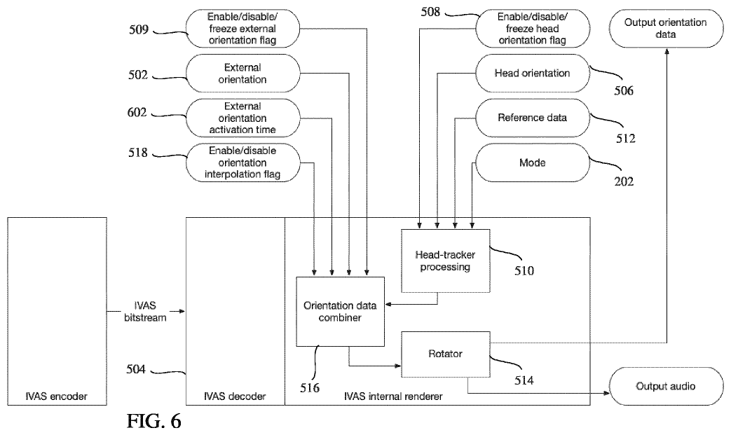

FIG. 6 illustrates a further extension of the proposed orientation handling according as described in FIG. 5. In this example, an additional input describing external orientation activation 602 time is added. The activation time 602 indicates that the currently provided external orientation 502 information is to be applied at a current frame (activation time 0) or a future frame (e.g., activation time 50 corresponding to 50 frames). For example, in professionally created “canned” content or any pre-planned portion of a real-time content, there may be an intent to change orientation at a specific point in time. For example, consider an immersive audio transmission of a panel discussion in front of a studio audience. The panel may first appear in front of a listener spanning an arc left to right. In a few moments, there may be a Q&A part of the discussion, at which point the scene is indicated to rotate such that the panel is to user's left and the audience is to user's right. This change in orientation may be planned and indicated at a future time (e.g., future frame). On the other hand, it may be desirable to make this change smooth. In this case, a new orientation may be sent in each frame or, rather, interpolation may be enabled. Thus, the renderer 504 calculates at each frame the target orientation depending on the current orientation, the external orientation 502, and the external orientation activation time 602. The orientation interpolation is thus particularly useful when a future orientation is known. Otherwise, an interpolation may provide a smooth orientation change, but such smooth orientation may lag behind, which may in some cases be perceived negatively by a user (listener). When the external orientation interpolation flag 518 is set as disabled with a non-zero orientation activation time, this corresponds to a wait command. For example, the renderer waits for X frames until the orientation is changed.

FIG. 6b. illustrates an alternative to FIG. 6, in accordance with an embodiment. In this embodiment, in addition to the external orientation flag 509, external orientation 502, and the external orientation activation time 602; the head orientation flag 508 is also provided as an input to the orientation data combiner 516. Further, in this embodiment, the orientation interpolation flag 518 is provided as an optional input to the orientation data combiner 516. Accordingly, all the operations not inherently part of head-tracker position, and/or operations related to user interactivity, may in embodiments be processed in the orientation data combiner 516.

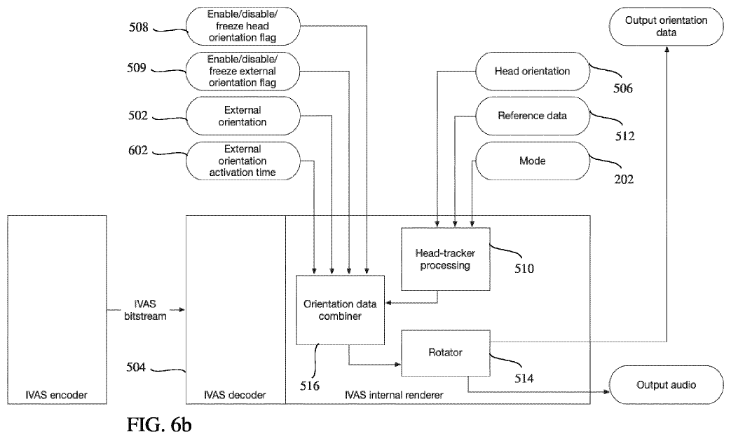

FIG. 7 illustrates an example additional description beyond system described in FIG. 6. This example describes example sources that may affect, at least, the external orientation data 502. For example, a sender UE may transmit scene orientation data 702 and device orientation data 704; and the receiver UE can provide local scene orientation data 706. The transmit scene orientation data 702, the device orientation data 704, and the local scene orientation data 706 and any other suitable orientation data maybe combined externally by an external orientation data combiner 708, which is external to the renderer 504.

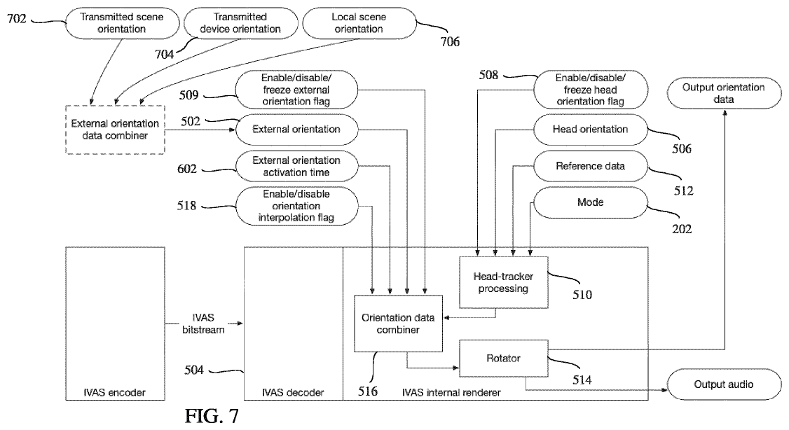

FIG. 8 is an example apparatus 800, which may be implemented in hardware, caused to implement external orientation control for conversational immersive audio, based on the examples described herein. The apparatus 800 comprises at least one processor 802, at least one non-transitory memory 804 including computer program code 805, wherein the at least one memory 804 and the computer program code 805 are configured to, with the at least one processor 802, cause the apparatus 800 to external orientation control for conversational immersive audio, based on the examples described herein.

The apparatus 800 optionally includes a display 808 that may be used to display content during rendering. The apparatus 800 optionally includes one or more network (NW) interfaces (I/F(s)) 810. The NW I/F(s) 810 may be wired and/or wireless and communicate over the Internet/other network(s) via any communication technique. The NW I/F(s) 810 may comprise one or more transmitters and one or more receivers. The N/W I/F(s) 810 may comprise standard well-known components such as an amplifier, filter, frequency-converter, (de)modulator, and encoder/decoder circuitry(ies) and one or more antennas.

An example of the apparatus 800 may be a remote, virtual or cloud apparatus. The apparatus 800 may be either a coder or a decoder, or both a coder and a decoder. The at least one memory 804 may be implemented using any suitable data storage technology, such as semiconductor based memory devices, flash memory, magnetic memory devices and systems, optical memory devices and systems, fixed memory and removable memory. The at least one memory 804 may comprise a database for storing data. The apparatus 800 need not comprise each of the features mentioned, or may comprise other features as well. The apparatus 800 may correspond to or be another embodiment of the apparatuses shown in FIG. 1, including UE 110, RAN node 170, or network element(s) 190.

Another example of apparatus 800 an IVAS internal renderer. Yet another example of the apparatus includes an external renderer, e.g., a renderer that may not be specified as part of the IVAS standard and may be used instead of the IVAS standard renderer(s). This may allow manufacturer differentiation of capabilities, and the like.

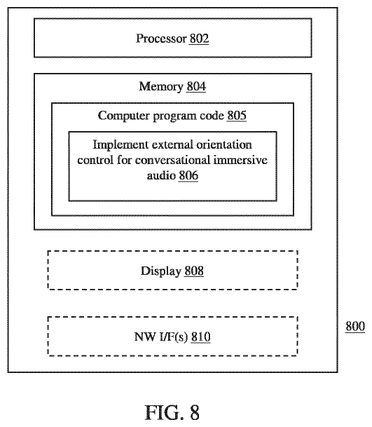

FIG. 9 shows a schematic representation of non-volatile memory media 900a (e.g., computer/compact disc (CD) or digital versatile disc (DVD)) and 900b (e.g., universal serial bus (USB) memory stick) storing instructions and/or parameters 902 which when executed by a processor allows the processor to perform one or more of the steps of the methods described herein.

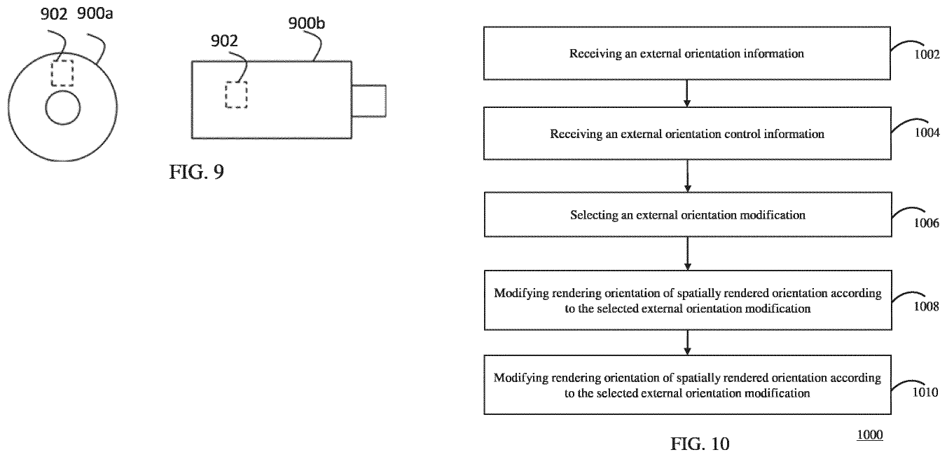

FIG. 10 is an example method 1000 to implement the examples described herein, in accordance with an embodiment. At 1002, the method 1000 includes receiving an external orientation information. At 1004, the method 1000 includes receiving an external orientation control information. At 1006, the method 1000 includes selecting an external orientation modification. In an embodiment, the external orientation modification is selected based on the received external orientation control information. At 1008, the method 1000 includes modifying rendering orientation of spatially rendered orientation according to the selected external orientation modification. At 1010, the method 1000 includes rendering spatial audio according to the modified rendering orientation.

In an embodiment, the external orientation control information comprises a flag for freezing head orientation to a last rendered spatial audio orientation. In another embodiment, the external orientation control information comprises a flag to enable or disable head-tracking. When the flag is set to disable the head-tracking, the head tracking is disabled and audio is rendered with disabled head tracking and default or corresponding front orientation. When the flag is set to enable the head-tracking, the head tracking is enabled and audio is rendered based on head orientation.

The method 1000 may further include receiving head-tracking information, and rendering the spatial audio further based on the head-tracking information.

The method 1000 may be performed with an apparatus described herein, for example, the apparatus 800, and the like.

As described above, FIG. 10 includes flowchart of an apparatus (e.g., 800), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 125, or 804) of an apparatus employing an embodiment of the present invention and executed by processing circuitry (e.g. 120, or 802) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIG. 10. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising:
at least one processor; and
at least one non-transitory memory storing instructions that, when executed with the at least one processor, cause the apparatus to perform:
receiving an external orientation information;
receiving an external orientation control information;
selecting an external orientation modification;
modifying rendering orientation of spatially rendered orientation according to the selected external orientation modification; and
rendering spatial audio according to the modified rendering orientation.

2. The apparatus as claimed in claim 1, wherein the external orientation control information comprises interactive interaction signal to enable, disable, or freeze application of the external orientation information.

3. The apparatus as claimed in claim 1, wherein the apparatus is further caused to, receive head-tracking information, and wherein the spatial audio is rendered further based on the head-tracking information.

4. The apparatus as claimed in claim 1, wherein the external orientation control information comprises a head orientation flag for freezing head orientation to a last rendered spatial audio orientation.

5. The apparatus as claimed in claim 1, wherein the external orientation control information comprises a head orientation flag to enable or disable head-tracking.

6. The apparatus as claimed in claim 4, wherein when the head orientation flag is set to disable the head-tracking, the head tracking is disabled and audio is rendered with disabled head tracking and default of corresponding front orientation.

7. The apparatus as claimed in claim 4, wherein when the head orientation flag is set to enable the head-tracking, the head tracking is enabled and audio is rendered based on head orientation.

8. The apparatus as claimed in claim 1, wherein the apparatus is further caused to:
receive a reference data for defining a scene orientation; and
apply the scene orientation data.

9. The apparatus as claimed in claim 1, wherein the apparatus is further caused to combine the external orientation data with head tracking data.

10. The apparatus as claimed in claim 1, wherein the apparatus is further caused to receive external orientation activation time for indicating that the external orientation information is to be applied at a current frame or at a future frame.

11. The apparatus as claimed in claim 1, wherein the apparatus is further caused to receive combined information affecting the external orientation information, and wherein the combined information comprises a combination of two or more of a scene orientation information provided by a sender user equipment (UE), device orientation data provided by the sender UE, or local scene orientation information provided by a receiver UE.

12. A method comprising:
receiving an external orientation information;
receiving an external orientation control information;
selecting an external orientation modification;
modifying rendering orientation of spatially rendered orientation according to the selected external orientation modification; and
rendering spatial audio according to the modified rendering orientation.

13. The method as claimed in claim 12, wherein the external orientation control information comprises interactive interaction signal to enable, disable, or freeze application of the external orientation information.

14. The method as claimed in claim 12 further comprising receiving head-tracking information, wherein the spatial audio is rendered further based on the head-tracking information.

15. The method as claimed in claim 12, wherein the external orientation control information comprises a head orientation flag for freezing head orientation to a last rendered spatial audio orientation.

16. The method as claimed in claim 12, wherein the external orientation control information comprises a head orientation flag to enable or disable head-tracking.

17. The method as claimed in claim 16, wherein when the head orientation flag is set to disable the head-tracking, the head tracking is disabled and audio is rendered with disabled head tracking and default or corresponding front orientation.

18. The method as claimed in claim 16, wherein when the head orientation flag is set to enable the head-tracking, the head tracking is enabled and audio is rendered based on head orientation.

19. The method as claimed in claim 12 comprising:
receiving a reference data for defining a scene orientation; and
applying the scene orientation data.

20. The method as claimed in claim 12 further comprising combining the external orientation data with head tracking data.

21. The method as claimed in claim 12 further comprising receiving external orientation activation time for indicating that the external orientation information is to be applied at a current frame or at a future frame.

22. The method as claimed in claim 12 further comprising receiving combined information affecting the external orientation information, and wherein the combined information comprises a combination of two or more of a scene orientation information provided by a sender user equipment (UE), device orientation data provided by the sender UE, or local scene orientation information provided by a receiver UE.

23. (canceled)

24. (canceled)
